(19) United States
(12) Patent Application Publication
(10) Pub. No.: US 2026/0301420 A1
(43) Pub. Date: Oct. 1, 2026

(54) COMPUTING DEVICE AND METHOD FOR PREDICTING PEDESTRIAN'S BEHAVIOR

(71) Applicant: ELECTRONICS AND TELECOMMUNICATIONS RESEARCH INSTITUTE, Daejeon (KR)

(72) Inventors: Je-Seok Ham, Daejeon (KR); Jin Young Moon, Daejeon (KR); Yongjin Kwon, Daejeon (KR); Daehoe Kim, Daejeon (KR); JONGHEE KIM, Daejeon (KR); Sungchan Oh, Daejeon (KR)

(21) Appl. No.: 19/346,656

(22) Filed: Oct. 1, 2025

(30) Foreign Application Priority Data
Mar. 31, 2025 (KR) 10-2025-0041354

(51) Int. Cl. G06V 20/58; G06T 7/246; G06V 10/25; G06V 10/77; G06V 10/82; G06V 20/40; G06V 40/20

(52) U.S. Cl. CPC G06V 20/58; G06T 7/246; G06V 10/25; G06V 10/77; G06V 10/82; G06V 20/46; G06V 40/20; G06T 2207/10016; G06T 2207/30196; G06T 2207/30252

(57) ABSTRACT

Provided are a computing device and method for predicting a pedestrian's behavior. The method includes collecting scene context of a road and objects, bounding box information of a pedestrian, local context of the pedestrian, and ego-vehicle speed information, inputting the scene context, the bounding box information, the local context, the ego-vehicle speed information, and a preset text prompt into a multimodal large language model (MLLM), and acquiring a prediction result of the pedestrian's behavior from the MLLM.

### CROSS-REFERENCE TO RELATED APPLICATION

This application claims priority to and the benefit of Korean Patent Application No. 10-2025-0041354, filed on Mar. 31, 2025, the disclosure of which is incorporated herein by reference in its entirety.

### BACKGROUND

### 1. Field of the Invention

The present invention relates to a technology for an autonomous vehicle to predict a pedestrian's behavior. Particularly, the present invention relates to a technology for an autonomous driving system installed in an autonomous vehicle to determine a pedestrian's behavioral intention by utilizing a multimodal large language model (MLLM). The present invention corresponds to a technology for integrating computer vision (CV) and natural language processing (NLP) to process various data, such as text, images, vehicle speed information, etc., on the basis of a deep learning model.
This work was supported by an Institute of Information & Communications Technology Planning & Evaluation (IITP) grant funded by the Korean government (MSIT) (RS-2020-1120004, Development of Provisional Intelligence Based on Long-term Visual Memory Network)

### 2. Description of Related Art

In autonomous driving technology, a technique for predicting the behavior, such as road walking (e.g., crossing), etc., of pedestrians is a key technology for traffic safety that enables vehicles to respond appropriately. In other words, an autonomous vehicle may predict a pedestrian's intention to cross a road and plan a safer driving route to prevent an accident. Existing methods mainly utilize a deep learning network (e.g., a long short-term memory (LSTM), a gated recurrent unit (GRU), or a three-dimensional convolutional neural network (3DCNN)) to predict a pedestrian's behavior. For example, an LSTM-based model processes temporal data to predict a pedestrian's behavior on the basis of the pedestrian's trajectory, and a GRU model integrates multiple pieces of information (e.g., a pedestrian's appearance, a surrounding context, a posture, a vehicle speed, etc.) to predict a pedestrian's behavior. Also, 3DCNNs and convolutional LSTMs (ConvLSTMs) integrate spatial information and temporal information to predict a pedestrian's behavior. However, these methods primarily depend on training datasets, and thus generalization performance thereof is poor in new driving environments or complex road conditions. In addition, existing techniques often depend on a single piece of information, and in the case of graph convolutional networks (GCNs), it is more difficult to process redundant relationships with an increase in the number of objects. Visual models based on a deep learning network such as a 3DCNN and a ConvLSTM are limited by the high computational cost of training.

The recent emergence of multimodal large language models (MLLMs) has offered a new approach to solve these problems. MLLMs offer new possibilities for understanding and predicting pedestrians' behavior even in complex road environments on the basis of integrated processing of images and text and a human-like reasoning capability. Models such as a generative pre-trained transformer (GPT)-4V(ision) show strengths in analyzing road elements, such as pedestrians, vehicles, and traffic signals, in temporal sequence and understanding pedestrian-vehicle interactions. In addition, DriveGPT4 helps an autonomous vehicle make decisions by converting video inputs into text-based interpretations, and Talk2BEV utilizes bird's eye view (BEV) data to enable visual and verbal reasoning in autonomous vehicles.

However, the above-described existing techniques focus on understanding a pedestrian's behavior, and there are relatively few techniques for predicting a pedestrian's road walking.

### SUMMARY

The present invention is directed to providing a new device and method for precisely predicting road walking of a pedestrian by utilizing a multimodal large language model (MLLM). Specifically, the present invention is directed to providing a new device and method for precisely predicting road walking using a multimodal vision language model (MVLM) or a closed-source MLLM.

The present invention is directed to providing a method of effectively processing various types of multimodal data, such as text, images, vehicle speed information, etc., to determine a pedestrian's crossing intention.

Objects of the present invention are not limited to those described above, and other objects which have not been described will be clearly understood by those of ordinary skill in the art from the following description.

According to an aspect of the present invention, there is provided a road walking prediction device that is a computing device for predicting a pedestrian's behavior. The road walking prediction device includes a memory configured to store computer-readable instructions and at least one processor configured to execute the instructions.

By executing the instructions, the at least one processor collects scene context which is a set of video frames in which a road and objects on the road are captured, bounding box information which is a set of coordinates of a bounding box surrounding the pedestrian in the frames, local context which is a set of images of the pedestrian extracted from the frames, and ego-vehicle speed information and inputs the scene context, the bounding box information, the local context, the ego-vehicle speed information, and a preset text prompt into an MLLM to acquire a prediction result of the pedestrian's behavior.

According to another aspect of the present invention, there is provided a method of predicting a pedestrian's behavior performed by a computing device.

The method of predicting a pedestrian's behavior includes a data collection operation of collecting scene context which is a set of video frames in which a road and objects on the road are captured, bounding box information which is a set of coordinates of a bounding box surrounding the pedestrian in the frames, local context which is a set of images of the pedestrian extracted from the frames, and ego-vehicle speed information, an operation of inputting the scene context, the bounding box information, the local context, the ego-vehicle speed information, and a preset text prompt into an MLLM, and an operation of acquiring a prediction result of the pedestrian's behavior from the MLLM.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a block diagram of a road walking prediction device according to an exemplary embodiment of the present invention;

FIG. 2 is a flowchart of a road walking prediction method according to an exemplary embodiment of the present invention;

FIG. 3 is a block diagram illustrating a road walking prediction method employing VideoLLaMA2 which is an open-source multimodal large language model (MLLM);

FIG. 4 is a set of exemplary views of scene context;

FIG. 5 is a block diagram showing a detailed configuration of a spatial-temporal connector (STC) model;

FIG. 6 shows an example of a text prompt;

FIG. 7 shows an example of bounding box information;

FIG. 8 shows an example of ego-vehicle speed information;

FIGS. 9A and 9B show examples of a result of predicting a pedestrian's walking;

FIG. 10 is a block diagram illustrating a road walking prediction method using generative pre-trained transformer (GPT)-4 omni (4o) which is a closed-source MLLM;

FIG. 11 shows examples of prediction performance maps in accordance with observation time and prediction time;

FIGS. 12A and 12B are example views qualitatively showing a scene-understanding capability of a first exemplary embodiment of the present invention;

FIGS. 13A and 13B are example views qualitatively showing a result of predicting road walking of a pedestrian according to the first exemplary embodiment of the present invention;

FIGS. 14A and 14B are example views qualitatively showing a result of predicting a pedestrian's non-road walking according to the first exemplary embodiment of the present invention; and

FIG. 15 is an example view qualitatively showing a result of predicting a pedestrian's road walking according to a second exemplary embodiment of the present invention.

### DETAILED DESCRIPTION OF EXEMPLARY EMBODIMENTS

A list of references of the present invention is given below in [1] to [3]. References [1] to [3] are incorporated herein by reference in their entireties.
[1] Zesen Cheng et al., “VideoLLaMA 2: Advancing spatial_temporal Modeling and Audio Understanding in Video-LLMs,” arXiv:2406.07476, http://doi.org/10.48550/arXiv.2406.07476, Jun. 11, 2024.
[2] Je-Seok Ham, S. Kim, P. Jiang, J. Moon, S. Saripalli, and Changick Kim, “LLaMAPed: Multi-modal Pedestrian Crossing Intention Prediction,” in Proc. IEEE/CVF European Conference on Computer Vision Workshops (ECCVW), Milano, Italy, Sep. 30, 2024.
[3] Je-Seok Ham, J. Huang, P. Jiang, J. Moon, Y. Kwon, S. Saripalli, and Changick Kim. “OmniPredict: GPT-4o Enhanced Multi-modal Pedestrian Crossing Intention Prediction,” in Proc. the 38^{th} Annual Conference on Neural Information Processing Systems Workshop (NeurIPSW), Vancouver, Canada, Dec. 14, 2024.

The object of the present invention is to provide a device and method for precisely predicting road walking of a pedestrian by utilizing a multimodal large language model (MLLM). Specifically, the present invention proposes a method of effectively processing various types of multimodal data, such as text, images, vehicle speed information, etc., to determine a pedestrian's crossing intention.

In order for an autonomous vehicle to understand and predict a pedestrian's behavior, there is a necessity for a technological approach for effectively processing various data sources and modeling interactions between pedestrians and vehicles in a complex driving environment. Existing visual model-based pedestrian behavior prediction models have the limitations of not efficiently handling relationships between multiple inputs and lacking generalization performance in untrained environments due to their dataset dependency. To overcome these limitations of existing technology, the present invention proposes an approach based on VideoLLaMA2 which is an open-source MLLM and a method of utilizing generative pre-trained transformer (GPT)-4 omni (4o) which is a closed-source MLLM. In particular, the present invention predicts a pedestrian's crossing intention by precisely performing mapping between text and images and provides high generalization prediction performance and reliability even in a new driving environment, contributing to enhancing safety and responsibility of autonomous vehicles.

Advantages and features of the present invention and methods of achieving them will become apparent with reference to embodiments described in detail below with the accompanying drawings. However, the present invention is not limited to the embodiments disclosed below and can be implemented in various different forms. The embodiments are only provided to make the disclosure of the present invention complete and fully convey the scope of the present invention to those skilled in the technical field to which the present invention pertains. The present invention is only defined by the scope of the claims. Meanwhile, the terminology used herein is for the purpose of describing the embodiments and is not intended to limit the present invention. In this specification, a singular form also includes a plural form unless particularly described otherwise. As used herein, the term “comprises” and/or “comprising” do not exclude the presence or addition of one or more constituent elements, steps, operations, and/or elements other than stated constituent elements, steps, operations, and/or elements.

Although the terms “first,” “second,” etc. may be used to describe various components, these components are not limited by these terms. The terms are only used to distinguish one component from others. For example, without departing from the scope of the present invention, a first component may be named a second component, and a second component may be named a first component.

It will be understood that, when a component is referred to as being “connected” or “coupled” to another component, the component may be directly connected or coupled to the other component or an intervening component may be present. On the other hand, it will be understood that, when a component is referred to as being “directly connected” or “directly coupled” to another component, there is no intervening component. Other expressions describing the relationship between components, such as “between,” “directly between,” “adjacent to,” “directly adjacent to,” etc., should be construed in the same way.

In describing the present invention, when it is determined that detailed description of a related known technology unnecessarily obscures the subject matter of the present invention, the detailed description will be omitted.

Hereinafter, exemplary embodiments of the present invention will be described in detail with reference to the accompanying drawings. In describing the present invention, to facilitate overall understanding, the same reference numeral will be used for the same component throughout the drawings.

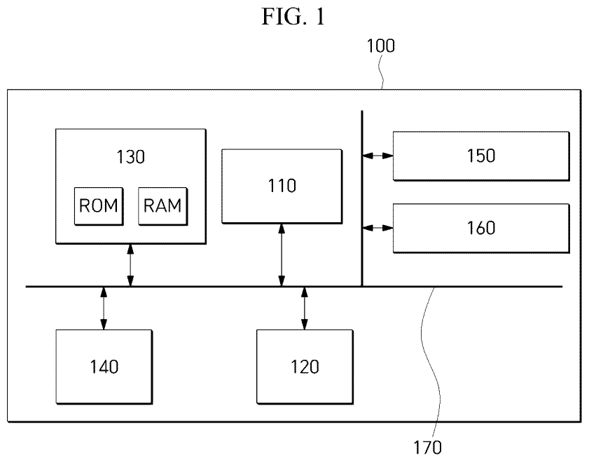

FIG. 1 is a block diagram of a road walking prediction device according to an exemplary embodiment of the present invention. A road walking prediction device 100 according to an exemplary embodiment of the present invention may be implemented in the form of a computing device (computer system) of FIG. 1.

Referring to FIG. 1, the road walking prediction device 100 may include at least one of at least one processor 110, a memory 130, an input interface device 150, an output interface device 160, and a storage device 140 which communicate through the bus 170. The road walking prediction device 100 may further include a communication device 120 coupled to a network.

The road walking prediction device 100 shown in FIG. 1 is in accordance with an exemplary embodiment. Components of the road walking prediction device 100 of the present invention are not limited to the exemplary embodiment shown in FIG. 1, and may be added, changed, or removed as necessary.

The processor 110 may be a central processing unit (CPU) or a semiconductor device that executes instructions stored in the memory 130 or the storage device 140.

The memory 130 and the storage device 140 may include various forms of volatile or non-volatile storage media. For example, the memory 130 may include a read-only memory (ROM) and a random access memory (RAM).

In exemplary embodiments of the present disclosure, the memory 130 may be inside or outside the processor 110, and the memory 130 may be connected to the processor 110 through various known devices. The memory 130 is various forms of volatile or non-volatile storage media and may include, for example, a ROM or a RAM.

Therefore, an exemplary embodiment of the present invention may be implemented as a method performed by a computer or a non-transitory computer-readable recording medium in which computer-executable instructions are stored. In an exemplary embodiment, when the computer-executable instructions are executed by the processor 110, a method according to at least one aspect of the present disclosure may be performed.

The communication device 120 may transmit or receive a wired signal or a wireless signal.

Also, a road walking prediction method according to an exemplary embodiment of the present invention may be implemented in the form of program instructions that may be executed by various computing devices, and recorded on a computer-readable recording medium.

The computer-readable recording medium may include program instructions, data files, data structures, etc., solely or in combination. The program instructions recorded on the computer-readable recording medium may be specially designed for exemplary embodiments of the present invention or well known and available to those of ordinary skill in the field of computer software. The computer-readable recording medium may include a hardware device configured to store and execute program instructions. Examples of the computer-readable recording medium may be magnetic media such as a hard disk, a floppy disk, and magnetic tape, optical media such as a compact disc (CD)-ROM and a digital video disc (DVD), magneto-optical media such as a floptical disk, a ROM, a RAM, a flash memory, and the like. The program instructions may include not only machine code such as that generated by a compiler but also high-level language code that is executable by a computer using an interpreter or the like.

By executing computer-executable instructions stored in the memory 130 or the storage device 140, the processor 110 may collect scene context SC which is a set of video frames in which a road and objects (including a pedestrian) on (or near) the road are captured, bounding box information BB which is a set of coordinates of a bounding box surrounding the pedestrian in the frames, local context LC which is a set of images of the pedestrian extracted from the video frames, and ego-vehicle speed information SPD and input the scene context SC, the bounding box information BB, the local context LC, the ego-vehicle speed information SPD, and a preset text prompt TP into an MLLM to acquire a prediction result PRD of the pedestrian's behavior.

The ego-vehicle speed information SPD may be information that categorizes a speed level of an ego vehicle as any one of moving fast, accelerating, decelerating, moving slow, and stopped on the basis of the ego-vehicle speed.

The text prompt TP may include 1) a role definition part that instructs the processor 110 to predict the pedestrian's behavior after a set number of frames, 2) a multimodal data utilization part that instructs the processor 110 to utilize the scene context SC, the bounding box information BB, the local context LC, and the ego-vehicle speed information SPD in predicting the pedestrian's behavior, and 3) a behavior definition part that categorizes the pedestrian's behavior as crossing or non-crossing and includes definitions of crossing and non-crossing.

The MLLM may be an open-source MLLM or a closed-source MLLM.

In the present specification, a first exemplary embodiment is an embodiment in which the road walking prediction device 100 predicts a pedestrian's behavior using an open-source MLLM, and a second exemplary embodiment is an embodiment in which the road walking prediction device 100 predicts a pedestrian's behavior using a closed-source MLLM.

In the first exemplary embodiment, the MLLM further includes a spatial-temporal connector (STC) model (hereinafter, “STC”) that integrates temporal information and spatial information of consecutive frames.

In the first exemplary embodiment, the processor 110 inputs the scene context SC into a first visual encoder to encode the scene context SC, inputs the local context LC into a second visual encoder to encode the local context LC, inputs encoded scene context SCE and encoded local context LCE into the STC for conversion, and inputs the scene context SCD and the local context LCD converted by the STC, the bounding box information BB, the ego-vehicle speed information SPD, and the text prompt TP into the MLLM to acquire a pedestrian behavior prediction result PRD.

In the first exemplary embodiment, the MLLM may be VideoLLaMA2. The STC may include a downsampling operator for reducing a resolution of the encoded scene context SCE and the encoded local context LCE in accordance with a setting, and a RegStage block for combining features of different spatial locations.

In the second exemplary embodiment, the MLLM is a closed-source MLLM. In this case, the processor 110 generates frame sequence observation data Seq by extracting data from the scene context SC, the bounding box information BB, the local context LC, and the ego-vehicle speed information SPD in accordance with the temporal order of the video frames and grouping the extracted data and then inputs the frame sequence observation data Seq and the text prompt TP into the MLLM to acquire a pedestrian behavior prediction result PRD.

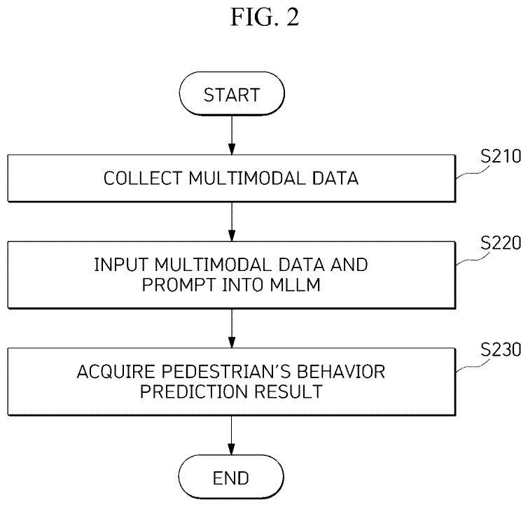

Functions of the road walking prediction device 100 will be described in detail below with reference to FIGS. 2 to 10.

FIG. 2 is a flowchart of a road walking prediction method according to an exemplary embodiment of the present invention. The road walking prediction method may be performed by the road walking prediction device 100. The road walking prediction device 100 may be installed in an autonomous vehicle (hereinafter, “ego vehicle”).

Referring to FIG. 2, the road walking prediction method according to an exemplary embodiment of the present invention includes operations S210, S220, and S230. The road walking prediction method shown in FIG. 2 is in accordance with an exemplary embodiment. Operations of the road walking prediction method of the present invention are not limited to the exemplary embodiment shown in FIG. 2, and may be added, changed, or removed as necessary.

Operation S210 is a multimodal data collection operation.

The processor 110 of the road walking prediction device 100 collects scene context SC which is a set of video frames in which a road and objects (e.g., a pedestrian, a crosswalk, and vehicles) on (or near) the road are captured, bounding box information BB which is a set of coordinates of a bounding box surrounding the pedestrian in the video frames, local context LC which is a set of images of the pedestrian extracted from the video frames, and ego-vehicle speed information SPD from the communication device 120 or the input interface device 150 and stores the scene context SC, the bounding box information BB, the local context LC, and the ego-vehicle speed information SPD in the memory or the storage device 140.

Operation S220 is an operation of inputting the multimodal data collected in operation S210 and a text prompt TP into the MLLM, and operation S230 is an operation of acquiring a pedestrian behavior prediction result PRD from the MLLM.

Depending on operations S220 and S230, the road walking prediction method according to an exemplary embodiment of the present invention is classified as the first exemplary embodiment or the second exemplary embodiment.

In the first exemplary embodiment, the road walking prediction device 100 predicts a pedestrian's behavior using an open-source MLLM, and in the second exemplary embodiment, the road walking prediction device 100 predicts a pedestrian's behavior using a closed-source MLLM.

Description of the first exemplary embodiment will be followed by that of the second exemplary embodiment. The first exemplary embodiment is a road walking prediction method employing VideoLLaMA2 which is an open-source MLLM, and the second exemplary embodiment is a road walking prediction method employing GPT-4o which is a closed-source MLLM.

First exemplary embodiment: road walking prediction method employing open-source MLLM VideoLLaMA2

The processor 110 may determine a pedestrian's crossing intention by utilizing VideoLLaMA2 which is an open-source MLLM. VideoLLaMA2 is a model trained using a large amount of video data and includes an STC for integrating information of consecutive frames. The processor 110 may analyze the pedestrian's behavior shown in observed consecutive frames through the STC and precisely predict the pedestrian's crossing intention at the time when the pedestrian will cross the road.

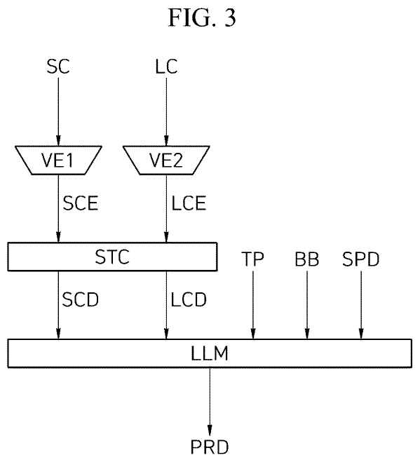

FIG. 3 is a block diagram illustrating a road walking prediction method employing VideoLLaMA2 which is an open-source MLLM.

VideoLLaMA2 includes an STC for integrating temporal information and spatial information of consecutive frames and an LLM. Here, the STC may include a downsampling operator for reducing a resolution of encoded scene context SCE and encoded local context LCE in accordance with a set resolution, and a RegStage block for combining features of different spatial locations. The LLM included in VideoLLaMA2 is an open-source LLM and may be constructed on the basis of any one of various models. For example, the LLM may be a Mistral-instruct-based model, a Mixtral-instruct-based model, or a Qwen2-instruct-based model.

To predict a pedestrian's road walking using VideoLLaMA2, the processor 110 uses four major kinds of multimodal input data (SC, LC, BB and SPD). The multimodal input data includes scene context SC, local context LC, bounding box information BB, and ego-vehicle speed information SPD.

The processor 110 encodes the scene context SC by inputting the scene context SC into a first visual encoder VE1 and generates encoded scene context SCE. Also, the processor 110 encodes the local context LC by inputting the local context LC into a second visual encoder VE2 and generates encoded local context LCE.

The processor 110 inputs the encoded scene context SCE and the encoded local context LCE into the STC model to generate converted scene context SCD and converted local context LCD.

The processor 110 inputs the scene context SCD and the local context LCD converted by the STC, the bounding box information BB, the ego-vehicle speed information SPD, and a text prompt TP into the LLM to generate a pedestrian's behavior prediction result PRD.

The text prompt TP may include at least one or a combination of 1) a role definition part that instructs the processor 110 to predict the pedestrian's behavior after a set number of frames, 2) a multimodal data utilization part that instructs the processor 110 to utilize the scene context SC, the bounding box information BB, the local context LC, and the ego-vehicle speed information SPD in predicting the pedestrian's behavior, and 3) a behavior definition part that categorizes the pedestrian's behavior as crossing or non-crossing and includes definitions of crossing and non-crossing.

The input data SC, LC, BB, and SPD is mathematically defined as follows. In the following description of the input data, N represents an observation section, and i is an index of multimodal data of an i^{th} pedestrian.

### (a) Scene Context SC

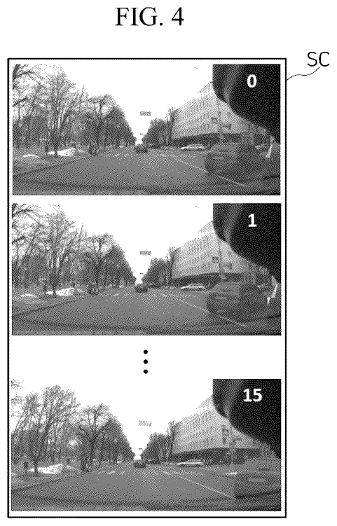

The scene context SC represents an overall road scene (see FIG. 4). The scene context SC includes not only pedestrians but also all objects on the road. Scene context SC for an i^{th} pedestrian is defined as follows.

$${SC}_{i} ∈ {ℝ}^{N \times 1} = \{ {sc}_{c}^{i} \vert t = 1 , … , N \} , \qquad [ Equation 1 ]$$

Here, scₜⁱ is a scene context image including the i^{th} pedestrian at a time point t. For example, the scene context image may be an input image with a resolution of 1920×1080. In this case, the processor 110 may adjust sizes of all scene context images (e.g., 336×336 pixels) to input the scene context images into the VideoLLaMA2 model. In scene context images, bounding boxes surrounding pedestrians may be shown in red.

### (b) Bounding Box Information BB

The bounding box information BB may be defined as shown in Equation 2.

$${L}_{i} ∈ {ℝ}^{N \times 4} = \{ ( {x}_{br , i}^{t} , {x}_{tl , i}^{t} , {y}_{br , i}^{t} , {y}_{tl , i}^{t} ) \vert t = 1 , … , N \} , \qquad [ Equation 2 ]$$

The bounding box information (BB) Lᵢ represents a two-dimensional (2D) bounding box of the i^{th} pedestrian at the time point t. Lᵢ includes an x coordinate of a bottom right point, an x coordinate of a top left point, a y coordinate of the bottom right point, and a y coordinate of the top left point of the bounding box surrounding the pedestrian.

### (c) Speed of the Ego Vehicle SE

The ego-vehicle speed (SPD or SE) may be defined as shown in Equation 3.

$$SE ∈ {ℝ}^{N \times 1} = \{ {se}_{t} \vert t = 1 , … , N \} , \qquad [ Equation 3 ]$$

seₜ included in the ego-vehicle speed SPD represents an ego-vehicle speed at the time point t. seₜ may be an ordered variable. For example, seₜ may be an ordered variable categorized into 5 levels. In this case, a speed level (or speed information) expressed as seₜ may be a result of categorizing a speed of an autonomous vehicle as one of moving fast, accelerating, decelerating, moving slow, and stopped. In other words, the ego-vehicle speed information SPD may be information categorizing a speed level of the ego vehicle as any one of moving fast, accelerating, decelerating, moving slow, and stopped on the basis of the speed of the ego vehicle.

The processor 110 may convert text data of the ego-vehicle speed information SPD into a tensor and use the tensor as an input to the LLM. Examples of prediction criteria of the LLM based on the ego-vehicle speed information SPD are given below.
Moving fast or accelerating: it is highly likely that the pedestrian will not cross after 30 frames.
Decelerating, moving slow, or stopped: it is highly likely that the pedestrian will cross after 30 frames.

### (d) Local Context LCᵢ

The local context LC may be defined as shown in Equation 4.

$${LC}_{i} ∈ {ℝ}^{N \times 1} = \{ l {c}_{t}^{i} \vert t = 1 , … , N \} , \qquad [ Equation 4 ]$$

The local context LCᵢ is the local context LC of the i^{th} pedestrian. lcᵢ included in the local context LCᵢ represents an image (local context image) of the i^{th} pedestrian. The local context LCᵢ expresses detailed information of the pedestrian. For example, the processor 110 may generate a local context image by cropping 1.5 times the area of a bounding box of the pedestrian and then converting the cropped area to a standardized resolution for all pedestrians at a size of 224×224 pixels. Then, the processor may also convert the local context image into a tensor with a size of 336×336 which is available in VideoLLaMA2. Even in the local context image, a red box may be shown on the basis of the bounding box of the pedestrian.

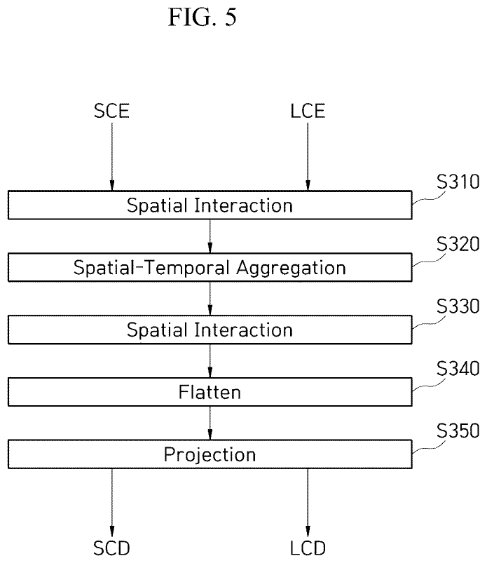

FIG. 5 is a block diagram showing a detailed configuration of an STC.

VideoLLaMA2 which is an open-source MLLM utilized in the first exemplary embodiment of the present invention includes an STC to process spatio-temporal elements in an integrated manner and maintains a spatio-temporal order by utilizing an approach based on convolution and pooling instead of existing Q-former. The STC applies a 3D downsampling operator and adds a RegStage convolution block (Radosavovic et al., 2020) before and after downsampling to minimize information loss. Based on this design, VideoLLaMA2 effectively learns temporal relationships of consecutive frames and improves prediction accuracy.

As shown in FIG. 5, the STC receives encoded scene context SCE and encoded local context LCE and outputs converted scene context SCD and converted local context LCD through a first spatial interaction process S310, a spatial-temporal aggregation process S320, a second spatial interaction process S330, a flattening process S340, and a projection process S350.

S310 is the first spatial interaction process, in which spatial features are enhanced. In the first spatial interaction process, features of different spatial locations are combined. The process may be implemented using a RegStage block. The RegStage block is a key design feature of the STC and is a convolutional neural network (CNN)-based convolutional block that compensates for information loss caused by spatio-temporal downsampling.

S320 is the spatial-temporal aggregation process, in which spatial features of individual frames are learned and then the information is combined on a time-axis. In the spatial-temporal aggregation process, a three-dimensional (3D) downsampler is used. In this process, relationships between several frames are learned, and the temporal consistency of a video is taken into consideration. Through this process, VideoLLaMA2 can process multiple frames. The spatial-temporal aggregation process is designed using 3D convolution and pooling rather than a resampler architecture which is used by existing models. This is because resampling operations do not ensure a spatio-temporal order and may adversely affect a consistent token order of an LLM.

S330 is the second spatial interaction process. This process is used to optimize a spatial expression with temporal information included. The RegStage block may also be used in this process.

S340 is the flattening process, in which an input value of process S340 is converted into a 2D token such that the LLM may understand 3D spatial-temporal features. For example, an output of process S340 may be in the form of a 2D matrix.

S350 is a projection process, in which 2D tokens generated in process S340 are arranged in a specific dimension that is usable by the LLM. In this process, dimensioning and feature transformations are performed such that the LLM may understand the 2D tokens.

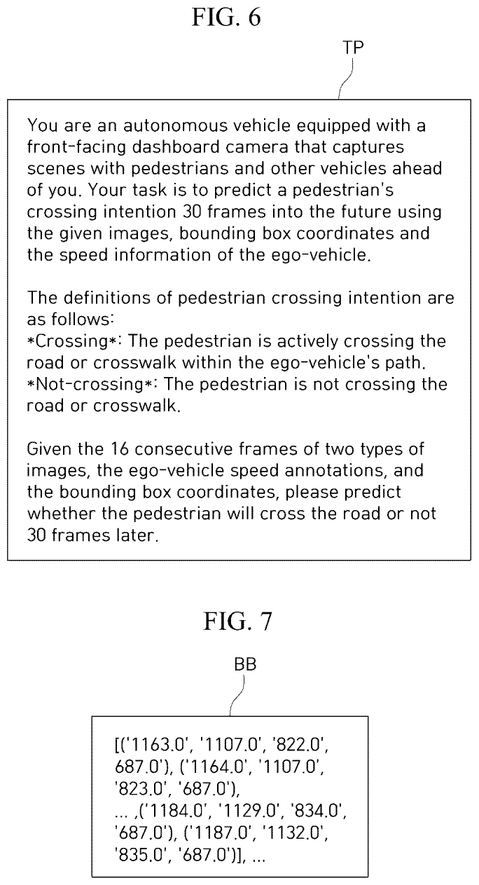

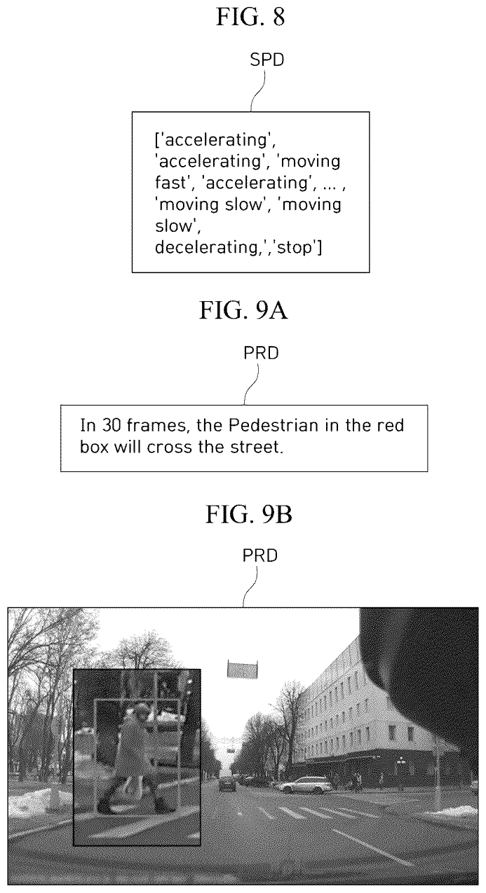

As described above, the processor 110 inputs the scene context SCD converted by the STC, the local context LCD converted by the STC, the bounding box information BB, the ego-vehicle speed information SPD, and the text prompt TP into the LLM to generate the pedestrian's behavior prediction result PRD. The behavior prediction result PRD may be a result (walking prediction result) of predicting whether the pedestrian will do road walking (cross the road). FIG. 6 shows an example of a text prompt TP, FIG. 7 shows an example of bounding box information BB, FIG. 8 shows an example of ego-vehicle speed information SPD, and FIGS. 9A and 9B show examples of a walking prediction result PRD of a pedestrian. The walking prediction result PRD may be presented as text or an image by the LLM.

When the processor 110 inputs the text prompt TP and the multimodal data SCD, LCD, BB, and SPD into the LLM, the LLM processes the input multimodal data SCD, LCD, BB, and SPD on the basis of the text prompt TP and performs a prediction task. The STC and/or the LLM may be a model installed in the road walking prediction device 100 or a model operating in an external server.

In the present invention, the LLM is assigned a task of predicting a pedestrian's behavior after m future frames on the basis of information of n past frames according to an existing benchmark evaluation method based on a visual model.

As described above, the text prompt TP transmitted to the LLM by the processor 110 may include at least one or a combination of 1) a role definition part that instructs the processor 110 to predict the pedestrian's behavior after a set number of frames, 2) a multimodal data utilization part that instructs the processor 110 to utilize the scene context SC, the bounding box information BB, the local context LC, and the ego-vehicle speed information SPD in predicting the pedestrian's behavior, and 3) a behavior definition part that categorizes the pedestrian's behavior as crossing or non-crossing and includes definitions of crossing and non-crossing. The text prompt TP may further include 4) an input data and output data setting part (hereinafter, “I/O setting part”) that clearly specifies data to be input into the LLM and data to be output by the LLM.

### 1) Role Definition Part

The text prompt TP may include a part that sets the LLM to predict a pedestrian's behavior after a certain number of frames on the basis of a scene captured through a camera installed in the ego vehicle. The following is an example of the role definition part of the text prompt TP, which instructs the LLM to predict the pedestrian's behavior after 30 frames on the basis of given input features. In the present specification, description between “““and””” corresponds to a prompt.

question=“““You are an autonomous vehicle equipped with a front-facing dashboard camera that captures scenes with pedestrians and other vehicles ahead of you. Your task is to predict a pedestrian's crossing intention 30 frames into the future using the given images, bounding box coordinates and the speed information of the ego-vehicle.”””

### 2) Multimodal Data Utilization Part

The text prompt TP may include a part that instructs the LLM to utilize the multimodal data SC, LC, BB, and SPD to predict the pedestrian's behavior.

The following is an example of a prompt which instructs utilization of the four kinds of multimodal data.

“““You will receive two types of images, each consisting of 16 frames from the past as input:
Scene Context image: An image with a resolution of 1920×1080, representing the entire scene. Focus on the behavior of the pedestrian inside the red box, which corresponds to the bounding box size.
Local Context Image: An image obtained by cropping an area 1.5 times the size of the pedestrian's bounding box and resizing it to 224×224. Similarly, focus on the behavior of the pedestrian inside the red box, which corresponds to the bounding box size in this image.

Additionally, you will be provided with the following:
Bounding box coordinates of the pedestrian. The bounding box coordinates are composed of (the x coordinate of the bottom right, the x coordinate of the top left, the y coordinate of the bottom right, the y coordinate of the top left).
Ego-vehicle speed information is categorized into five levels: moving fast, accelerating, moving slow, decelerating, stopped.

If the ego-vehicle annotation is labeled as accelerating or moving fast, the pedestrian is more likely not to be crossing 30 frames later.

If the ego-vehicle annotation is labeled as moving slow, decelerating, or stopped, the pedestrian is more likely to be crossing 30 frames later.”””

### 3) Behavior Definition Part

The text prompt TP may include the behavior definition part that categorizes the pedestrian's behavior as crossing or non-crossing and includes definitions of crossing and non-crossing. For example, in the behavior definition part, “crossing” may represent a case where the pedestrian crosses the road or a crosswalk in a travel direction of the ego vehicle, and “non-crossing” may represent any case where the pedestrian does not cross the road or a crosswalk. The pedestrian's behavior may be applied irrespective of the travel direction of the ego vehicle. The following is an example of the behavior definition part that may be included in the text prompt TP.

“““The definitions of pedestrian crossing intention are as follows:
*Crossing*: The pedestrian is actively crossing the road or crosswalk within the ego-vehicle's path.
*Non-crossing*: The pedestrian is not crossing the road or crosswalk.”””

### 4) I/O Setting Part

The text prompt TP may include the behavior definition part that specifies input data and output data (I/O setting part). The following is an example of the I/O setting part included in the text prompt TP.

“““Given the 16 consecutive frames of two type of images, the ego-vehicle speed annotations, and the bounding box coordinates, please predict whether the pedestrian will cross the road or not 30 frames later.”””

In operation S230, the LLM outputs the pedestrian's behavior prediction result PRD on the basis of the input multimodal data SCD, LCD, BB, and SPD in accordance with an instruction specified in the text prompt TP. As described above, the pedestrian's behavior prediction result PRD may be in the form of text or an image (see FIGS. 9A and 9B).

The second exemplary embodiment which is an embodiment of a road walking prediction method employing a closed-source MLLM will be described below.

Second exemplary embodiment: road walking prediction method employing closed-source MLLM GPT-4o

In performing operations S220 and S230, the processor 110 may determine the pedestrian's crossing intention by utilizing a closed-source MLLM. The second exemplary embodiment is an embodiment of determining a pedestrian's crossing intention using GPT-4o which is a closed-source MLLM.

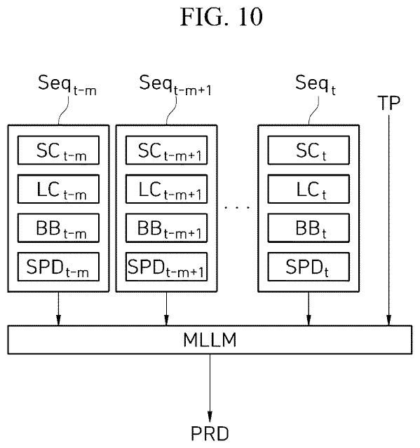

GPT-4o has been designed to provide more natural functions in interactions between a human and a computer than GPT-4V which is its preceding model. This model shows excellent performance in understanding visual things and works as a comprehensive multimodal model. A method of predicting a pedestrian's road walking using GPT-4o which is a closed-source MLLM is shown in FIG. 10.

FIG. 10 is a block diagram illustrating a road walking prediction method using GPT-4o which is a closed-source MLLM.

The processor 110 inputs frame sequence observation data Seq and a text prompt TP into an LLM and acquires a pedestrian's behavior prediction result PRD.

As shown in FIG. 10, the frame sequence observation data Seq includes observation data Seqₜ₋ₘ, Seqₜ₋ₘ₊₁, . . . , and Seqₜ corresponding to each time point. Each piece of observation data may include four kinds of multimodal input data SC, LC, BB, and SPD generated at the corresponding time point. The input data is mathematically defined as follows. Here, i is an index of multimodal data of an i^{th} pedestrian.

A scene context image SCᵢ is data included in scene context SC. The scene context image SCᵢ may be presented as shown in Equation 5.

$${SC}_{i} = \{ {sc}_{i}^{t - 15} , {sc}_{i}^{t - 14} , {sc}_{i}^{t - 13} , … , {sc}_{i}^{t 0} \} , \qquad [ Equation 5 ]$$

In Equation 5, scᵢ represents an overall image, that is, a road scene, including all objects such as pedestrians, a crosswalk, vehicles, etc., in a road environment. For example, a scene context image may be an image with a size of 1920×1080 pixels. In the scene context image, bounding boxes surrounding pedestrians may be shown in red.

A local context image LCᵢ is data included in local context LC. The local context image LCᵢ may be presented as shown in Equation 6.

$${LC}_{i} = \{ {lc}_{i}^{t - 15} , {lc}_{i}^{t - 14} , {lc}_{i}^{t - 13} , … , {lc}_{i}^{t 0} \} , \qquad [ Equation 6 ]$$

lcᵢ^{t} included in the local context LCᵢ indicates an image (local context image) of the i^{th} pedestrian at a time point t. The local context image lcᵢ^{t} represents detailed information of the pedestrian. For example, the processor 110 may generate a local context image by cropping 1.5 times the area of a bounding box of the pedestrian and then converting the cropped area to a standardized resolution for all pedestrians at a size of 224×224 pixels. Like in the scene context image, a bounding box of a pedestrian may be shown in red in the local context image. Using the pedestrian's bounding box, GPT-4o which is a closed-source MLLM may focus on the pedestrian's movement and body orientation to make a prediction.

The bounding box information BB may be expressed as a set Bᵢ of bounding box coordinates of the i^{th} pedestrian at each time point as shown in Equation 7.

$${B}_{i} = \{ {b}_{i}^{t - 15} , {b}_{i}^{t - 14} , {b}_{i}^{t - 13} , … , {b}_{i}^{t 0} \} , \qquad [ Equation 7 ]$$

In Equation 7, bᵢ represents coordinates of a 2D bounding box of the i^{th} pedestrian. bᵢ may be defined as shown in Equation 8.

$${b}_{i} = [ {x}_{tl} , {y}_{tl} , {x}_{br} , {y}_{br} ] ∈ {ℝ}^{4} \qquad [ Equation 8 ]$$

As shown in Equation 8, bᵢ represents x and y coordinates (xₜₗ, yₜₗ) of a top-left point and x and y coordinates (x_{br}, y_{br}) of a bottom-right point.

The ego-vehicle speed information SPD or ES may be expressed as a set of ego-vehicle speeds es^{t} at different time points as shown in Equation 9.

$$ES = \{ {es}^{t - 15} , {es}^{t - 14} , {es}^{t - 13} , … , {es}^{t 0} \} , \qquad [ Equation 9 ]$$

In Equation 9, es^{t} is a speed of an ego-vehicle (autonomous vehicle) at a time point t and may be an ordered variable. For example, es^{t} may be an ordered variable categorized into 5 levels. In this case, a speed level (or speed information) expressed as es^{t} may be a result of categorizing a speed of an autonomous vehicle as one of moving fast, accelerating, decelerating, moving slow, and stopped. GPT-4o predicts a pedestrian's road walking using the speed information of the autonomous vehicle. The processor 110 may predict the pedestrian's road walking on the basis of the four kinds of multimodal input data SC, LC, BB, and SPD described above by utilizing GPT-4o which is a closed-source MLLM.

As shown in FIG. 10, the processor 110 may generate frame sequence observation data Seq by extracting data from the scene context SC, the bounding box information BB, the local context LC, and the ego-vehicle speed information SPD in accordance with the temporal order of video frames acquired from the camera installed in the ego vehicle and grouping the extracted data and then input the frame sequence observation data Seq and the text prompt TP into the closed-source MLLM to acquire a walking prediction result PRD. In FIG. 10, the frame sequence observation data Seq includes observation data Seqₜ₋ₘ, Seqₜ₋ₘ₊₁, . . . , and Seqₜ corresponding to each time point. Each piece of observation data may include four kinds of multimodal input data SC, LC, BB, and SPD generated at the corresponding time point. For example, the observation data Seqₜ at the time point t includes a scene context image SCₜ, a local context image LCₜ, bounding box information BBₜ, and ego-vehicle speed information SPD. The processor 110 inputs the observation data Seqₜ₋ₘ, Seqₜ₋ₘ₊₁, . . . , and Seqₜ corresponding to each time point and the text prompt TP into the closed-source MLLM and acquires the pedestrian's behavior prediction result PRD. For example, the behavior prediction result PRD may be a result (walk prediction result) of predicting whether the pedestrian will cross the road. In other words, the road walking prediction device 100 may use a sequence of past frames as an input to a closed-source MLLM to predict whether the pedestrian will be walking on the road at a specific future time point.

Like in the first exemplary embodiment, in the second exemplary embodiment shown in FIG. 10, the text prompt TP may include at least one or a combination of 1) a role definition part that instructs the processor 110 to predict the pedestrian's behavior after a set number of frames, 2) a multimodal data utilization part that instructs the processor 110 to utilize the scene context SC, the bounding box information BB, the local context LC, and the ego-vehicle speed information SPD in predicting the pedestrian's behavior, and 3) a behavior definition part that categorizes the pedestrian's behavior as crossing or non-crossing and includes definitions of crossing and non-crossing.

For example, the text prompt TP may include the role definition part. The role definition part assigns a role of the autonomous vehicle to the MLLM and indicates that provided images are captured by a front-view dashboard camera. For example, the role definition part may be configured to cause the MLLM to process data of 16 past frames and predict the pedestrian's road walking after 30 frames.

“““You are an autonomous vehicle equipped with a front-view dashboard camera. The camera captures the scene in front of the ego-vehicle, including pedestrians and other vehicles. The video is recorded at 30 frames per second (fps). Your task is to predict a pedestrian's behavior 30 frames into the future based on the provided images, bounding box coordinates, and ego-vehicle speed information.”””

Also, the text prompt TP may include a behavior definition part as shown in the following example. Here, a main criterion for crossing may be whether the pedestrian's movement is toward the autonomous vehicle, and whether the pedestrian is crossing the road or crosswalk is also considered an important factor.

“““The definitions of pedestrian behavior are as follows:
* Crossing *:
   ** crossing **: The pedestrian is actively crossing the road or crosswalk within the ego-vehicle's path.
   ** non-crossing **: The pedestrian is not crossing the road or crosswalk.”””

Based on such a prompt design, an MLLM can precisely predict and output a pedestrian's future behavior by utilizing ample context data.

The first and second exemplary embodiments of the present invention have been described above. A device and method according to the present invention may predict a pedestrian's road walking through an approach (first exemplary embodiment) based on VideoLLaLA2 which is an open-source MLLM, and an approach (second exemplary embodiment) based on GPT-4o which is a closed-source MLLM as described above. The present invention employs multiple input sources, and a text prompt designed for this also falls within the scope of the present invention. The present invention differs from existing visual deep learning model technologies in that the present invention enables predictions in a zero-shot setting which requires no additional training.

The road walking prediction method has been described above with reference to the flowchart shown in the drawing. While the method has been shown and described as a series of blocks for the purpose of simplicity of explanation, the present invention is not limited by the order of the blocks. Some blocks may be performed in a different order than what is depicted and described herein, and/or concurrently with other blocks. Various other branches, flow paths, and orders of the blocks may be implemented that achieve the same or a similar result. In addition, not all the illustrated blocks may be required for implementing the method described herein.

Meanwhile, in the description of FIGS. 2 to 10, the operations may be subdivided into additional operations or combined into fewer operations depending on implementation of the present invention. As necessary, some operations may be omitted, or the order of operations may change. The description of FIGS. 2 to 10 may be applied to FIG. 1 even when the description is omitted. In addition, the description of FIG. 1 may be applied to FIGS. 2 to 10.

Evaluation results of the present invention will be described in detail below.

The present invention was evaluated on the basis of a Joint Attention in Autonomous Driving (JAAD) dataset. The JAAD dataset is composed of scenes showing interactions between pedestrians and vehicles in urban driving environments of North America and Eastern Europe, that were captured using a front-view camera installed in an ego-vehicle.

Metrics utilized for a comparison of the two approaches (the first and second exemplary embodiments) proposed in the present invention are accuracy ACC, area under the curve (AUC), and F1-score. The accuracy ACC is prediction accuracy and indicates how well the pedestrian's behavior prediction result PRD matches the ground truth. The accuracy ACC is calculated as shown in Equation 10.

$$ACC = = \frac{TP + TN}{TP + FP + TN + FN} \qquad [ Equation 10 ]$$

Here, TP is the number of positive cases that are predicted correctly, FP is the number of positive cases that are predicted incorrectly, TN is the number of negative cases that are predicted correctly, and FN the number of negative cases that are predicted incorrectly.

The F1-score represents the harmonic mean of precision and recall and may be presented as shown in Equation 11.

$$F 1 = \frac{2 \times precision \times recall}{precision + recall} \qquad [ Equation 11 ]$$

The AUC is used for evaluating performance of a binary classification model and indicates an area under a receiver operating characteristic (ROC) curve. The ROC curve is drawn on the basis of an x-axis representing a false positive rate (FPR) and a y-axis representing a true positive rate (TPR).

The FPR and the TPR may be presented as shown in Equation 12.

$$FPR = \frac{FP}{FP + TN} , TPR = \frac{TP}{TP + FN} \qquad [ Equation 12 ]$$

Here, false positive (FP) represents a case where the pedestrian's behavior prediction result PRD is actually negative but determined by the binary classification model as positive, true positive (TP) represents a case where the pedestrian's behavior prediction result PRD is actually positive and also determined by the binary classification model as positive, true negative (TN) represents a case where the pedestrian's behavior prediction result PRD is actually negative and also determined by the binary classification model as negative, and false negative (FN) represents a case where the pedestrian's behavior prediction result PRD is actually positive but determined by the binary classification model as negative.

The AUC may be defined as shown in Equation 13.

$$AUC = {\sum }_{i = 1}^{n - 1} \frac{1}{2} ( {x}_{i + 1} - {x}_{i} ) \cdot ( {y}_{i} + {y}_{i + 1} ) \qquad [ Equation 13 ]$$

Here, n is the total number of data points, xᵢ is an FPR value, yᵢ is a TPR value, and (xᵢ, yᵢ) is a point on the ROC curve. A high AUC value represents that the approach of the present invention can effectively distinguish between different classes.

First, effects of the method of predicting a pedestrian's road walking using VideoLLaMA2 which is an open-source MLLM according to the first exemplary embodiment will be described below.

Table 1 is a performance comparison table between the existing methodology and a case of predicting a pedestrian's road walking using VideoLLaMA2 which is an open-source MLLM.

TABLE 1

| | | Input | | | JAAD-beh | | | | |
|---|---|---|---|---|---|---|---|---|---|
| Models | Model Variants | Use Frames | Extra Info | Year | ACC | AUC | F1 | P | R |
| MultiRNN | GRU | 16 | / | 2018 | 0.61 | 0.50 | 0.74 | 0.64 | 0.86 |
| SFRNN | GRU | 16 | / | 2020 | 0.51 | 0.45 | 0.63 | 0.61 | 0.64 |
| SingleRNN-GRU | GRU | 16 | / | 2020 | 0.58 | 0.54 | 0.67 | 0.67 | 0.68 |
| SingleRNN-LSTM | LSTM | 16 | / | 2020 | 0.51 | 0.48 | 0.61 | 0.63 | 0.59 |
| PCPA | 3D CNN + RNN + Attention | 16 | / | 2021 | 0.58 | 0.50 | 0.71 | / | / |
| TrouSPI-Net | GRU + Attention | 16 | / | 2021 | 0.64 | 0.56 | 0.76 | 0.66 | 0.91 |
| IntFormer | Transformer | 16 | / | 2021 | 0.59 | 0.54 | 0.69 | / | / |
| ST Crossing Pose | GCN | 16 | / | 2022 | 0.63 | 0.56 | 0.74 | 0.66 | 0.83 |
| FFSTP | GRU + Attention | 16 | Seg | 2022 | 0.62 | 0.54 | 0.74 | 0.65 | 0.85 |
| PIT-Block | Transformer | 16 | / | 2023 | 0.70 | 0.65 | 0.81 | 0.71 | 0.93 |
| Hybird-Group | CNN + GRU + Attention | 16 | P_{3D}, Seg, V | 2024 | 0.61 | 0.67 | 0.79 | / | / |
| GPT4V-PBP | MLLM | 10 | Text Prompt | 2024 | 0.57 | 0.61 | 0.65 | 0.82 | 0.54 |
| GPT4V-PBP Skip | MLLM | 10 | Text Prompt | 2024 | 0.55 | 0.59 | 0.64 | 0.81 | 0.53 |
| LLaMAPed | MLLM | 16 | Text Prompt | 2024 | 0.58 | 0.59 | 0.59 | 0.67 | 0.52 |

The first exemplary embodiment (“LLAMAPed” model in Table 1) of the present invention is an approach for utilizing an open-source MLLM and using a text prompt as an additional input. Like existing vision-based benchmark models, in the first exemplary embodiment, 16 past frames were used as inputs to predict a pedestrian's behavior after 30 frames, achieving accuracy, AUC, and F1 values of 0.58, 0.59, and 0.59, respectively. GPT4V-PBP, which is a method of predicting a pedestrian's road walking by utilizing an existing MLLM, uses a paid token called GPT4V and performed with an accuracy value of 0.57, an AUC value of 0.61, and an F1-score of 0.65. Therefore, the approach based on VideoLLaMA2 which is an open-source MLLM proposed in the present invention outperformed the approach employing paid tokens by 1% p in accuracy, despite being an open-source model. This represents that the method proposed in the present invention effectively processes multiple frames to provide improved spatiotemporal understanding. In addition, although the method proposed in the present invention shows somewhat lower performance than PIT-Block (0.70, 0.65, and 0.81) which is the best performing one of existing vision-based models, this approach has the advantage of not requiring any training on datasets and measuring performance in a zero-shot setting. In addition, the method proposed in the present invention has the advantage of representing a balance between precision and recall, allowing the vehicle to react appropriately in dangerous situations while minimizing unnecessary braking, thus ensuring both pedestrian safety and road efficiency.

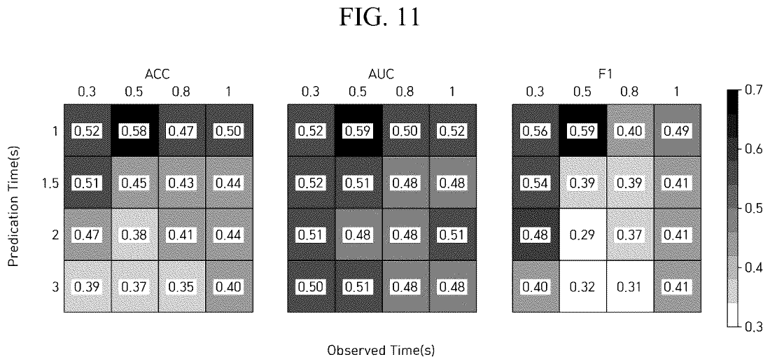

FIG. 11 shows examples of prediction performance maps in accordance with observed time and prediction time. In other words, FIG. 11 shows how prediction performance changes over observed time and prediction time. As shown in FIG. 11, with regard to all indicators, the highest performance was shown at an observed time of 0.5 seconds (16 frames) particularly when the prediction time was 1 second. The performance was gradually degraded with an increase in the prediction time and was degraded by the largest margin after 1.5 seconds. AUC is stably maintained compared with ACC and F1-score, which shows that AUC is less affected than the other indicators by time. As a result, an observed time of 0.5 seconds is required for optimal pedestrian road walking prediction performance, and it is important to minimize prediction time.

Table 2 shows a relationship between a pedestrian bounding box size ratio and prediction performance.

TABLE 2

| Bounding | Ratio of | | | | | |
|---|---|---|---|---|---|---|
| Box Ratio | Peds Count | ACC↑ | AUC↑ | F1↑ | P↑ | R↑ |
| 0.04-0.24 | 15.25% | 0.51 | 0.52 | 0.50 | 0.60 | 0.43 |
| 0.25-0.49 | 20.21% | 0.56 | 0.57 | 0.55 | 0.63 | 0.48 |
| 0.50-0.77 | 15.60% | 0.57 | 0.62 | 0.58 | 0.81 | 0.45 |
| 0.79-1.57 | 20.57% | 0.59 | 0.59 | 0.54 | 0.61 | 0.48 |
| 1.58-2.49 | 17.73% | 0.57 | 0.57 | 0.61 | 0.68 | 0.56 |
| 2.55-5.70 | 12.77% | 0.64 | 0.58 | 0.73 | 0.72 | 0.75 |

The pedestrian bounding box size ratio is a ratio of a pedestrian bounding box size to a total image size. Table 2 shows that, overall, prediction performance tends to improve with an increase in the size of a pedestrian bounding box. The section of 0.04 to 0.24 which is the smallest bounding box ratio showed 0.51, 0.52, and 0.50 which were the lowest prediction performance. The section of 2.55 to 5.70 which is the largest bounding box ratio showed 0.64, 0.58, and 0.73 which correspond to the highest prediction performance. These results represent that the proposed model shows higher prediction performance with an increase in the size of the bounding box, that is, an increase in the size of a pedestrian relative to the whole image. This is likely because a larger pedestrian bounding box contains more visual information and makes it possible to capture details that are important for predicting a pedestrian's road walking.

Table 3 shows performance changes made by removing four input features utilized by the model proposed in the present invention.

TABLE 3

| | | Ego- | | | | | | |
|---|---|---|---|---|---|---|---|---|
| Scene | Bounding | Vehicle | Local | | | | | |
| Context | Box | Speed | Context | ACC↑ | AUC↑ | F1↑ | P↑ | R↑ |
| ✓ | ✓ | ✓ | ✓ | 0.58 | 0.59 | 0.59 | 0.67 | 0.52 |
| ✓ | ✓ | — | — | 0.45 | 0.46 | 0.46 | 0.53 | 0.40 |
| ✓ | — | ✓ | — | 0.49 | 0.51 | 0.48 | 0.58 | 0.41 |
| ✓ | — | — | ✓ | 0.51 | 0.52 | 0.50 | 0.60 | 0.43 |
| ✓ | ✓ | ✓ | — | 0.49 | 0.50 | 0.48 | 0.58 | 0.41 |
| ✓ | — | ✓ | ✓ | 0.52 | 0.52 | 0.53 | 0.60 | 0.48 |
| ✓ | ✓ | — | ✓ | 0.54 | 0.55 | 0.53 | 0.63 | 0.46 |
| — | ✓ | ✓ | ✓ | 0.48 | 0.47 | 0.54 | 0.55 | 0.54 |

As shown in Table 3, when the four kinds of multimodal information SC, LC, BB, and SPD proposed in the present invention are all used, the highest prediction performance was achieved (ACC 0.58, AUC 0.59, and F1 0.59). When both local context and ego-vehicle speed information are removed from the input data, there was the largest degradation in the performance. The ACC, AUC, and F1 values were reduced to 0.45, 0.46, and 0.46, respectively. This shows that a combination of the two inputs plays an important role in a prediction of the model. Also, when only the scene context was removed from the input data, the performance was significantly degraded, resulting in the second lowest accuracy of 48%. This result confirms that removing road-wide context information degrades the overall scene understanding of the MLLM used in the present invention. In addition, when bounding box information is removed, location and area information of a pedestrian is lost, leading to performance degradation indicated by accuracy of 49%. Therefore, the prediction performance is significantly affected by all four features, and when all four features are combined, the best performance is achieved. In particular, it may be seen that the combination of the local context LC and the ego-vehicle speed SPD play an important role in the performance of the present invention.

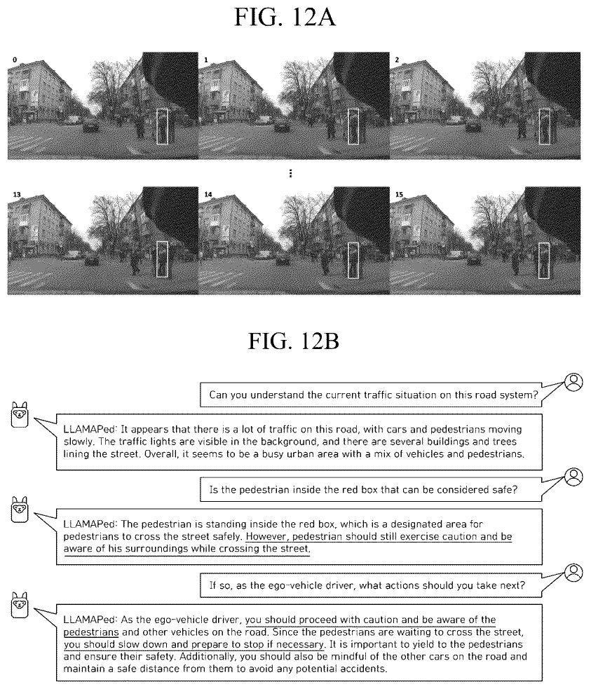

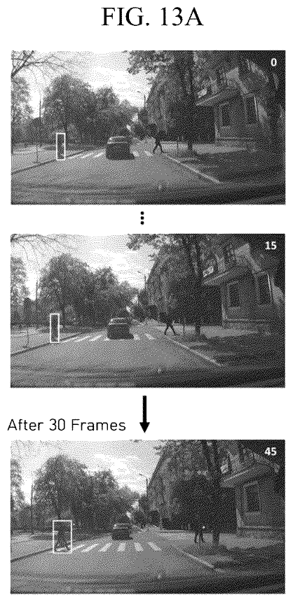

FIGS. 12A to 14B are views qualitatively showing how a pedestrian's road walking is predicted according to the method proposed in the present invention when an autonomous vehicle travels in a city. In FIGS. 12A to 14B, outputs of the road walking prediction device 100 according to the first exemplary embodiment are indicated as “LLaMAPed.”

FIGS. 12A and 12B are example views qualitatively showing a scene-understanding capability of the first exemplary embodiment of the present invention.

The MLLM understands a road situation on the basis of 16 preceding frame images (FIG. 12A) and sequentially responds to a user's queries. In response to a question asking whether a pedestrian in a box of FIG. 12A is safe, an output of the road walking prediction device 100 indicates that caution is still required and recommends that the vehicle driver carefully observe surroundings. Also, in response to the vehicle deriver asking what to do next, an output of the road walking prediction device 100 recommends to slow down and prepare to stop due to the presence of many pedestrians.

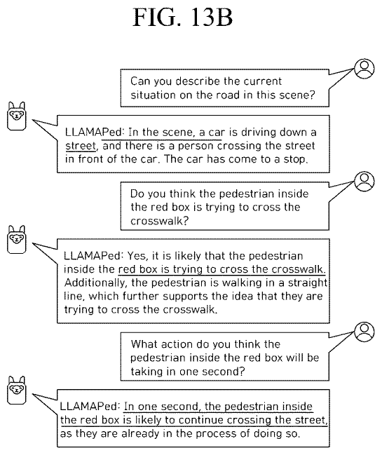

FIGS. 13A and 13B are example views qualitatively showing a result of predicting road walking of a pedestrian according to the first exemplary embodiment of the present invention.

The road walking prediction device 100 according to the first exemplary embodiment of the present invention recognized that the pedestrian in the box intended to cross the crosswalk and correctly predicted that the pedestrian would cross the road in the next second.

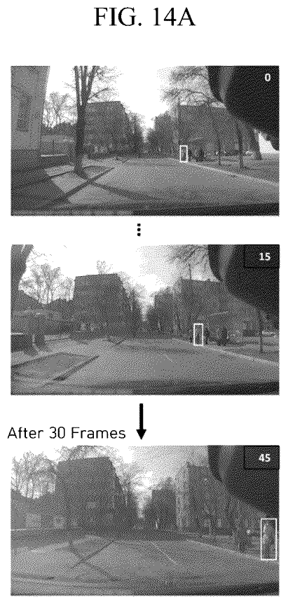

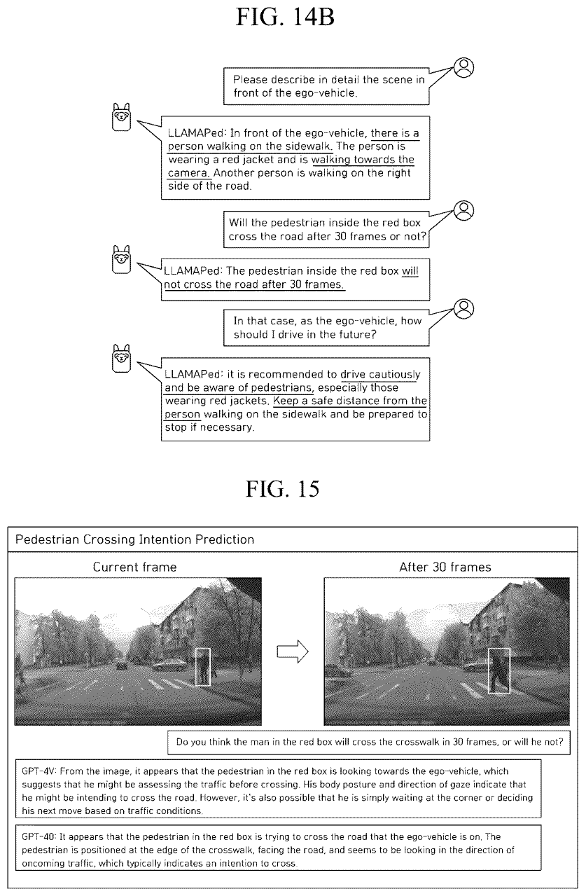

FIGS. 14A and 14B are example views qualitatively showing a result of predicting a pedestrian's non-road walking according to the first exemplary embodiment of the present invention.

FIG. 14B shows a quantitative result of correctly predicting that the pedestrian in the box of FIG. 14A will not enter the road after 30 frames. In addition, the road walking prediction device 100 recommends that the driver be careful and keep a safe distance. Therefore, according to the method proposed in the present invention, a road situation is well understood, and an accurate prediction and a reliable recommendation are provided to help a driver make a safer decision.

Evaluation results of the approach according to the second exemplary embodiment of the present invention will be described below.

Table 4 is a table for comparing performance of predicting a pedestrian's road walking between GPT-4o which is a closed-source MLLM and other models.

TABLE 4

| | | | | JAAD-beh | | | | |
|---|---|---|---|---|---|---|---|---|
| Models | Year | Model Variants | Use Frames | ACC↑ | AUC↑ | F1↑ | P↑ | R↑ |
| MultiRNN | 2018 | GRU | 16 | 0.61 | 0.50 | 0.74 | 0.64 | 0.86 |
| SFRNN | 2020 | GRU | 16 | 0.51 | 0.45 | 0.63 | 0.61 | 0.64 |
| SingleRNN | 2020 | GRU | 16 | 0.58 | 0.54 | 0.67 | 0.67 | 0.68 |
| PCPA | 2021 | RNN + Attention | 16 | 0.58 | 0.50 | 0.71 | \ | \ |
| IntFormer | 2021 | Transformer | 16 | 0.59 | 0.54 | 0.69 | \ | \ |
| ST CrossingPose | 2022 | Graph CNN | 16 | 0.63 | 0.56 | 0.74 | 0.66 | 0.83 |
| FFSTP | 2022 | GRU + Attention | 16 | 0.62 | 0.54 | 0.74 | 0.65 | 0.85 |
| PIT-Block(a) | 2022 | Transformer | 16 | 0.70 | 0.65 | 0.81 | 0.71 | 0.93 |
| GPT4V-PBP | 2023 | MLLM | 10 | 0.57 | 0.61 | 0.65 | 0.82 | 0.54 |
| GPT4V-PBP Skip | 2023 | MLLM | 10 | 0.55 | 0.59 | 0.64 | 0.81 | 0.53 |
| OmniPredict | 2024 | MLLM | 16 | 0.67 | 0.65 | 0.65 | 0.66 | 0.65 |

Table 4 is a table for comparing prediction performance between various existing domain-specific models for predicting a pedestrian's road walking after 30 frames and the second exemplary embodiment (“OmniPredict” model of Table 4) of the present invention. The models compared with the present invention include MultiRNN(2018) to GPT4V-PBP(2023). Among the existing domain-specific models, PIT-Block(a) achieved the best performance. However, this results from additional features that are not used by other models such as utilization of pedestrian 2D pose information. The GPT-based MLLMs according to the second exemplary embodiment showed competitive results without additional training. In particular, the approach based on GPT-4o, which is a closed-source MLLM, proposed in the present invention showed ACC, AUC, and F1 values of 0.67, 0.65, and 0.65, respectively. This approach showed 17.5% improvement in accuracy compared with GPT4V-PBP with the highest performance among existing MLLM models, achieving significant performance improvement. Also, the AUC value went up by 4%, showing the strength of the approach proposed in the present invention. In addition, the approach proposed in the present invention balances precision and recall, which emphasizes the robustness of the model. This balance is an important element in general classification problems and has the advantage of minimizing prediction errors while maintaining high performance, particularly, having strong prediction performance in complex driving scenarios.

FIG. 15 is an example view qualitatively showing a result of predicting a pedestrian's road walking according to the second exemplary embodiment of the present invention. In FIG. 15, a prediction result of GPT-4V and a prediction result of GPT-4o which is a closed-source MLLM are compared with each other.

Referring to FIG. 15, it is possible to see why GPT-4o has improved performance over GPT-4V while using the same input features. In response to a question asking whether a pedestrian standing at the edge of a sidewalk will cross the road after 30 frames, GPT-4V gives a relatively indecisive answer. GPT-4V presents both a possibility that the pedestrian will cross the road and a possibility that the pedestrian will stay there without crossing the road. On the other hand, according to the second exemplary embodiment of the present invention, GPT-4o gives a clearer prediction answer that the pedestrian will cross the road. In other words, according to the second exemplary embodiment of the present invention, GPT-4o generates a more reliable answer than GPT-4V. Therefore, the method proposed in the present invention provides higher accuracy and reliability in predicting a pedestrian's road walking in complex traffic situations.

Evaluation results of predicting a pedestrian's behavior according to the first and second exemplary embodiments of the present invention have been described above. The present invention supports stable decision making in various urban driving environments. In addition, the present invention does not require additional learning of datasets and thus can be applied to new road environments or unexpected driving scenarios. Therefore, the present invention is expected to be applicable to systems for integration with a traffic management system or systems for real-time vehicle driving.

To enhance the safety of autonomous vehicles, the present invention provides a necessary technical foundation for a variety of applications, such as predicting a pedestrian's behavior in a complex driving environment, analyzing interactions between pedestrians and vehicles, improving road safety, and the like.

Also, the present invention proposes a method of precisely performing mapping between text and images using an open-source MLLM and a closed-source MLLM to accurately determine a pedestrian's crossing intention.

Consequently, the present invention provides autonomous vehicles with high generalization prediction performance and reliability even in a new driving environment, contributing to traffic safety.

Effects of the present invention are not limited to those described above, and other effects which have not been described will be clearly understood by those of ordinary skill in the technical field to which the present invention pertains from the above description.

Although the present invention has been described above with reference to preferred embodiments, those skilled in the technical field should understand that the present invention can be changed or modified in various ways without departing from the spirit and scope of the present invention stated in the following claims.

What is claimed is:

1. A computing device for predicting a pedestrian's behavior, the computing device comprising:
a memory configured to store computer-readable instructions; and
at least one processor configured to execute the instructions,
wherein, by executing the instructions, the at least one processor collects scene context which is a set of video frames in which a road and objects on the road are captured, bounding box information which is a set of coordinates of a bounding box surrounding the pedestrian in the frames, local context which is a set of images of the pedestrian extracted from the frames, and ego-vehicle speed information and inputs the scene context, the bounding box information, the local context, the ego-vehicle speed information, and a preset text prompt into an multimodal large language model (MLLM) to acquire a prediction result of the pedestrian's behavior.

2. The computing device of claim 1, wherein the ego-vehicle speed information categorizes a speed level of an ego vehicle as any one of moving fast, accelerating, decelerating, moving slow, and stopped on the basis of an ego-vehicle speed.

3. The computing device of claim 1, wherein the text prompt includes a role definition part that instructs the at least one processor to predict the pedestrian's behavior after a set number of frames.

4. The computing device of claim 1, wherein the text prompt includes a multimodal data utilization part that instructs the at least one processor to utilize the scene context, the bounding box information, the local context, and the ego-vehicle speed information in predicting the pedestrian's behavior.

5. The computing device of claim 1, wherein the text prompt includes a behavior definition part that categorizes the pedestrian's behavior as crossing or non-crossing and includes definitions of crossing and non-crossing.

6. The computing device of claim 1, wherein the MLLM is an open-source MLLM including a spatial-temporal connector (STC) model that integrates temporal information and spatial information of consecutive frames, and
the at least one processor encodes the scene context by inputting the scene context into a first visual encoder and encodes the local context by inputting the local context into a second visual encoder,
inputs the encoded scene context and the encoded local context into the STC model to convert the encoded scene context and the encoded local context, and
inputs the scene context and the local context converted by the STC model, the bounding box information, the ego-vehicle speed information, and the text prompt into the MLLM to acquire the prediction result.

7. The computing device of claim 6, wherein the MLLM is VideoLLaMA2.

8. The computing device of claim 6, wherein the STC model includes:
a downsampling operator configured to reduce a resolution of the encoded scene context and the encoded local context in accordance with a setting, and
a RegStage block configured to combine features of different spatial locations.

9. The computing device of claim 1, wherein the MLLM is a closed-source MLLM.

10. The computing device of claim 9, wherein the at least one processor generates frame sequence observation data by extracting data from the scene context, the bounding box information, the local context, and the ego-vehicle speed information in a temporal order of the video frames and grouping the extracted data and then inputs the frame sequence observation data and the text prompt into the MLLM to acquire the prediction result.

11. A method of predicting a pedestrian's behavior performed by a computing device, the method comprising:
a data collection operation of collecting scene context which is a set of video frames in which a road and objects on the road are captured, bounding box information which is a set of coordinates of a bounding box surrounding the pedestrian in the frames, local context which is a set of images of the pedestrian extracted from the frames, and ego-vehicle speed information;
an operation of inputting the scene context, the bounding box information, the local context, the ego-vehicle speed information, and a preset text prompt into a multimodal large language model (MLLM); and
an operation of acquiring a prediction result of the pedestrian's behavior from the MLLM.

12. The method of claim 11, wherein the ego-vehicle speed information categorizes a speed level of an ego vehicle as any one of moving fast, accelerating, decelerating, moving slow, and stopped on the basis of an ego-vehicle speed.

13. The method of claim 11, wherein the text prompt includes a role definition part that instructs the computing device to predict the pedestrian's behavior after a set number of frames.

14. The method of claim 11, wherein the text prompt includes a multimodal data utilization part that instructs the computing device to utilize the scene context, the bounding box information, the local context, and the ego-vehicle speed information in predicting the pedestrian's behavior.

15. The method of claim 11, wherein the text prompt includes a behavior definition part that categorizes the pedestrian's behavior as crossing or non-crossing and includes definitions of crossing and non-crossing.

16. The method of claim 11, wherein the MLLM is an open-source MLLM further including a spatial-temporal connector (STC) model that integrates temporal information and spatial information of consecutive frames, and
the inputting of the text prompt into the MLLM comprises:
inputting the scene context into a first visual encoder to encode the scene context;
inputting the local context into a second visual encoder to encode the local context;
inputting the encoded scene context and the encoded local context into the STC model to convert the encoded scene context and the encoded local context; and
inputting the scene context and the local context converted by the STC model, the bounding box information, the ego-vehicle speed information, and the text prompt into the MLLM.

17. The method of claim 16, wherein the MLLM is VideoLLaMA2.

18. The method of claim 16, wherein the STC model includes:
a downsampling operator configured to reduce a resolution of the encoded scene context and the encoded local context in accordance with a setting, and
a RegStage block configured to combine features of different spatial locations.

19. The method of claim 11, wherein the MLLM is a closed-source MLLM.

20. The method of claim 19, wherein the inputting of the text prompt into the MLLM comprises generating frame sequence observation data by extracting data from the scene context, the bounding box information, the local context, and the ego-vehicle speed information in a temporal order of the video frames, and grouping the extracted data, and then inputting the frame sequence observation data and the text prompt into the MLLM.
